(19) United States
(12) Patent Application Publication
(10) Pub. No.: US 2020/0159816 A1
(43) Pub. Date: May 21, 2020

(54) METHODS AND SYSTEMS FOR AUTOMATICALLY DELIVERING CONTENT USING A REFRESH SCRIPT BASED ON CONTENT VIEWABILITY

(71) Applicants: Grant BOSTROM, Encinitas, CA (US); Keiran FLANIGAN, San Marcos, CA (US)

(72) Inventors: Grant BOSTROM, Encinitas, CA (US); Keiran FLANIGAN, San Marcos, CA (US)

(21) Appl. No.: 16/255,563

(22) Filed: Jan. 23, 2019

Related U.S. Application Data
(60) Provisional application No. 62/620,890, filed on Jan. 23, 2018.

(51) Int. Cl. G06F 17/21; G06F 3/0483; G06F 3/0485; G06Q 30/02

(52) U.S. Cl. CPC G06F 17/215; G06Q 30/0277; G06F 3/0485; G06F 3/0483

(57) ABSTRACT

In some embodiments, automatic delivery of content is provided with refresh rates when an ad unit is viewable on a web page is disclosed. The methods and systems may include changing the refresh rate depending on whether an ad unit is 50% or more in a viewable area and thus is considered viewable. The viewability of the ad unit may be changed based on scrolling of a web page or moving the ad unit.

### CROSS REFERENCE TO RELATED APPLICATION

This application claims priority from U.S. Provisional Application No. 62/620,890 filed on Jan. 23, 2018, which is hereby incorporated by reference in its entirety.

### BACKGROUND OF THE INVENTION

### 1. Field of the Invention

The present invention relates to automatically delivering content, and more particularly, relates to methods and systems for automatically delivering content that increases the usability and viewability of the delivered content using a refresh script which may change refresh rates when an ad unit is within a viewable area.

### 2. Background to the Invention

Content delivery, such as done by digital advertising over the Internet or similar networks has become commonplace. Digital advertising is typically done by serving advertisements that are rendered to users on web pages as they use the Internet. In many cases, multiple advertisements may be served or shown to a user on a single web page or over multiple web pages. In either case, a web page may be reloaded so that the same advertisement or a different advertisement may be shown to the user more or less often over a period of time. As one would expect, the more times the user sees or otherwise engages with the advertisement, the more profitable that ad is for both the advertiser and the publisher or website owner.

However, several technical problems exist with technology for displaying content, such as advertisements to users viewing a web page to ensure that the user sees or engages with the advertisement. A web page will use a standard refresh rate to render a new or same advertisement to the user. In many cases, current technologies assume that if a page is rendered for a display, such as in a web browser, all of its contents are viewed by the user. In fact, in many cases, the advertisement may never be viewed or engaged by a user because the user has not spent enough time on the web page or the advertisement is not viewable. For example, the actual display area may be smaller than the rendered web page, and less than all its contents (e.g., advertisements) are visible or viewable.

Prior attempts to solve the viewability problem have also failed. For example, some websites have exploited various techniques that enable the website to collect advertising revenue while minimizing or not even displaying an advertisement. Such mechanisms may include: setting various parameters such that an advertisement is not displayed; displaying an advertisement that only occupies a single pixel; or displaying an advertisement on an area of a web page that is not visible (e.g., in the background or on an area of the web page that has been scrolled out of the user's view).

In other cases, a large number of purchased advertisements may never be viewed because when a web page is refreshed or loads for the first time, the advertisements purchased on that page may be “below the fold” or off the screen, which requires the user to scroll down to see the advertisements. Moreover, in cases where websites or publishers use infinite scrolling from one article to the next, the advertisements may not be within the viewable area of the user when the page is loaded or refreshed.

Therefore, there is a need for a technology solution to determine automatically when content, such as digital advertisements should be refreshed or displayed on a web page that maximizes the viewability and effectiveness of the advertisement.

### SUMMARY

In one aspect, a computer-implemented method is disclosed and includes receiving an ad unit including content; determining automatically by executing a refresh script on a processor in real-time or substantially in real-time whether the ad unit is within an active viewport; when the ad unit is less than a viewable percentage within the active viewport, applying a first refresh rate; and when the ad unit is equal to or more than the viewable percentage within the active viewport, applying a second refresh rate faster than the first refresh rate.

The method may include that the viewable percentage is fifty percent. The refresh script may automatically call for new content when the ad unit is equal to or more than the viewable percentage. The method may include a web page wherein the web page includes infinite scrolling. The method may include calculating a continuous time when the ad unit is equal to or more than the viewable percentage and applying the second refresh rate.

The method may also include an active viewport that is equal to or less than a web page. The method may further include that the determining step occurs when there is one of a change of the viewable area on page scroll, window resize and tab change.

In another aspect, an apparatus including a memory and a microprocessor for executing a set of instructions that when executed by the microprocessor is disclosed to perform a method of: receiving by a microprocessor an ad unit including content; determining by a microprocessor automatically by executing a refresh script on a processor in real-time or substantially in real-time whether the ad unit is within an active viewport; when the ad unit is less than a viewable percentage within the active viewport, applying a first refresh rate. and when the ad unit is equal to or more than the viewable percentage within the active viewport, applying a second refresh rate faster than the first refresh rate.

### BRIEF DESCRIPTION OF THE FIGURES

The invention may be better understood by referring to the following figures. The components in the figures are not necessarily to scale, emphasis instead being placed upon illustrating the principles of the invention. In the figures, like reference numerals designate corresponding parts throughout the different views.

FIG. 1 illustrates components of a system for automatically triggering a digital advertisement in an embodiment.

FIG. 2 illustrates a system for automatically triggering a digital advertisement in an embodiment.

FIG. 3 illustrates a method for automatically triggering a digital advertisement in an embodiment.

FIG. 4 illustrates a web browser window for automatically triggering a digital advertisement in an embodiment

FIG. 5 illustrates setting a refresh rate for automatically triggering a digital advertisement in an embodiment.

FIG. 6 illustrates a method for automatically triggering a digital advertisement in an embodiment.

### DETAILED DESCRIPTION

Each of the additional features and teachings disclosed below can be utilized separately or in conjunction with other features and teachings to provide a device, system, and/or method for automatic content delivery using a refresh script that changes refresh rates based in part on the content being a viewable area. Representative examples of the present invention, which utilize many of these additional features and teachings both separately and in combination, will now be described in further detail with reference to the attached drawings. This detailed description is merely intended to teach a person of skill in the art further details for practicing preferred aspects of the present teachings and is not intended to limit the scope of the invention. Therefore, combinations of features and steps disclosed in the following detail description may not be necessary to practice the invention in the broadest sense, and are instead taught merely to particularly describe representative examples of the present teachings.

Moreover, the various features of the representative examples and the dependent claims may be combined in ways that are not specifically and explicitly enumerated to provide additional useful embodiments of the present teachings. In addition, it is expressly noted that all features disclosed in the description and/or the claims are intended to be disclosed separately and independently from each other for the purpose of original disclosure, as well as for the purpose of restricting the claimed subject matter independent of the compositions of the features in the embodiments and/or the claims. It is also expressly noted that all value ranges or indications of groups of entities disclose every possible intermediate value or intermediate entity for original disclosure, as well as for the purpose of restricting the claimed subject matter

Devices, methods, and systems are described for automatically delivering content based on when the content is viewable and a refresh script for adjusting refresh rates based on the viewability. It should be noted that “viewable” or “viewability” refers to when content is visible within a viewport of a web page to a user. A “viewport” is the user's visible area of a web page. The term “active” is meant to refer to the part of the web page that a user is viewing. It should be noted that the terms “advertisement” or “ad” are meant to refer to digital advertisements displayed over a computer. Content may include audio, video, digital graphics, or text. In some embodiments, the content may include online digital advertising. “Refresh” is meant to refer to an act or function of updating a display. A “refresh rate” is the amount of time between when a new impression of the same or different content is displayed. It is expressly noted that the methods, devices, and systems described herein may be applied automatically to any number of ads.

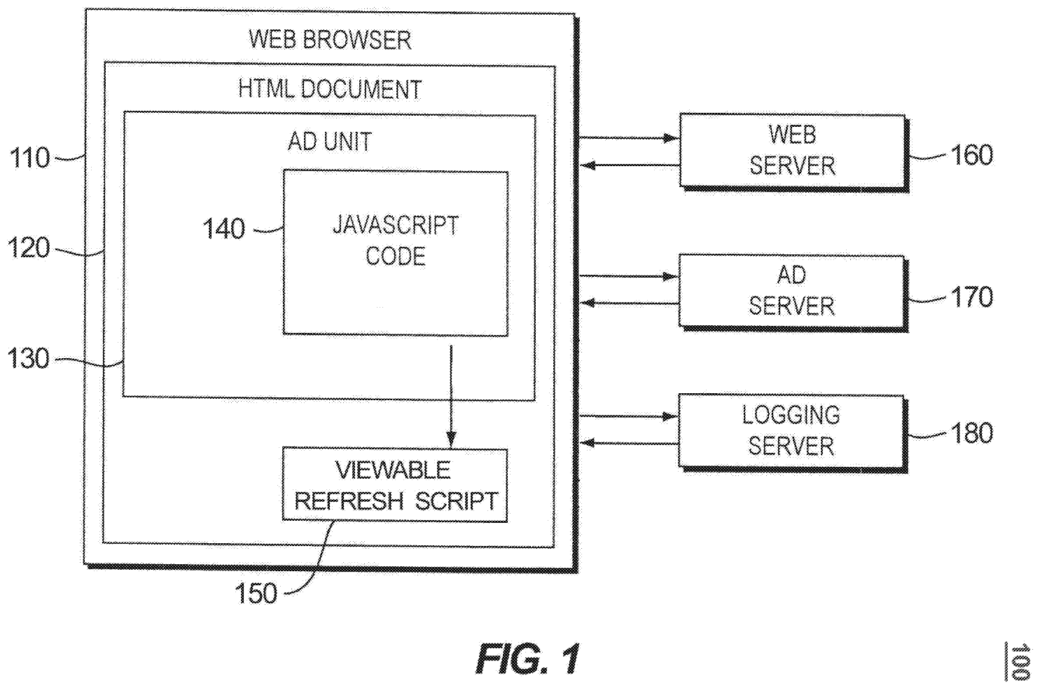

FIG. 1 shows a system 100 that may include a browser 110. The browser 110 may be any known application that is capable of displaying content in page form over a computer. Suitable web browsers include Google Chrome, Microsoft Internet Explorer, and Apple Safari. The browser may display web pages written in HTML, such as HTML document 120. The document 120 may include an ad unit 130, which defines the dimensions for the size of the display for the ad. The ad unit 130 may include Javascript code 140 that may be executed to display the advertisement. The Javascript code 140 may also include code that executes a refresh script 150, which allows ads to be refreshed at a refresh rate. In some embodiments, the refresh rate may be between approximately 5-60 seconds. It should be understood that the web page and/or browser may be viewed on any computing device including a laptop, tablet, desktop, mobile device, and television and the inventions described herein may be used on or with any of such computing devices. It should also be understood that the ad unit may be less than or equal to the size of the viewport. In one embodiment, the ad unit may be 300×250 pixels, 300×600 pixels, 728×90 pixels, 160×600 pixels, or 970×250 pixels in some embodiments.

As shown in FIG. 1, a web server 160 may host or store the document 120, an ad server 170 may host, store, or manage the JavaScript code 140 and a logging server 180 may handle the data and analysis of the refresh script 150. In one embodiment, the logging server may capture viewability data that may be used to set or select a refresh rate. Viewability data may include where the location of the ad unit is relative to an active viewport, where the location of the ad unit is inside the active viewport, and/or a timer indicating how long the ad unit is in the active viewport. The refresh script 150 may include code to measure the amount of time an ad unit is viewable, measure the viewability of an ad unit, and change the refresh rate.

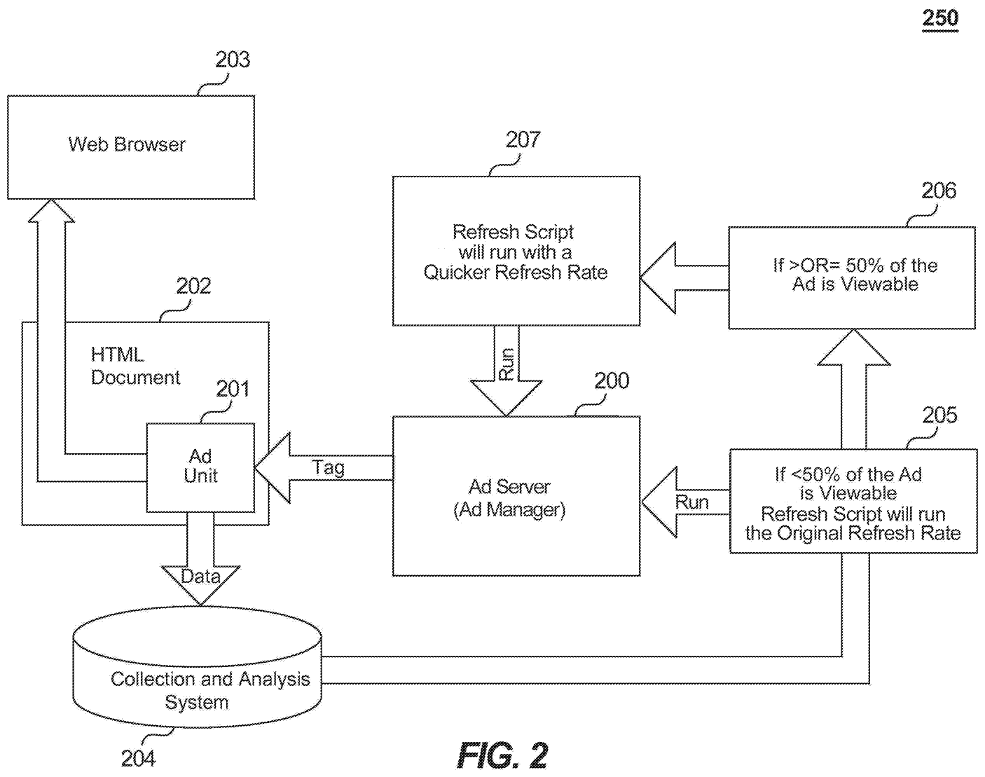

FIG. 2 shows a system 250 which may include an ad server or ad manager 200, which may add or generate the JavaScript code for the ad unit 201 on an HTML document or publisher website 202, which may be viewed through a web browser 203.

In one embodiment, when the JavaScript code has been loaded onto a browser 203, a refresh script may be executed and viewable data on the ad unit 201 may be captured and communicated to and from the collection and analysis system 204.

In an embodiment, if less than 50% of the ad unit is viewable, a refresh script may be executed that has an original refresh rate 205. If 50% or more of the ad unit is viewable, a faster refresh script with a faster refresh rate 207 may be executed and the script 207 may call for a new ad through the ad server 200, which will appear in the ad unit 201. In one embodiment, when the ad unit becomes viewable, a viewability timer may be used to determine if the ad unit stays viewable for a period of time. If the ad unit remains viewable, then the refresh script with the faster refresh rate may be used for a predetermined or random amount of time. In some embodiments, the refresh script with the refresh rate and a refresh script with a faster refresh rate may be made available to the same or different web pages at the same time or different times.

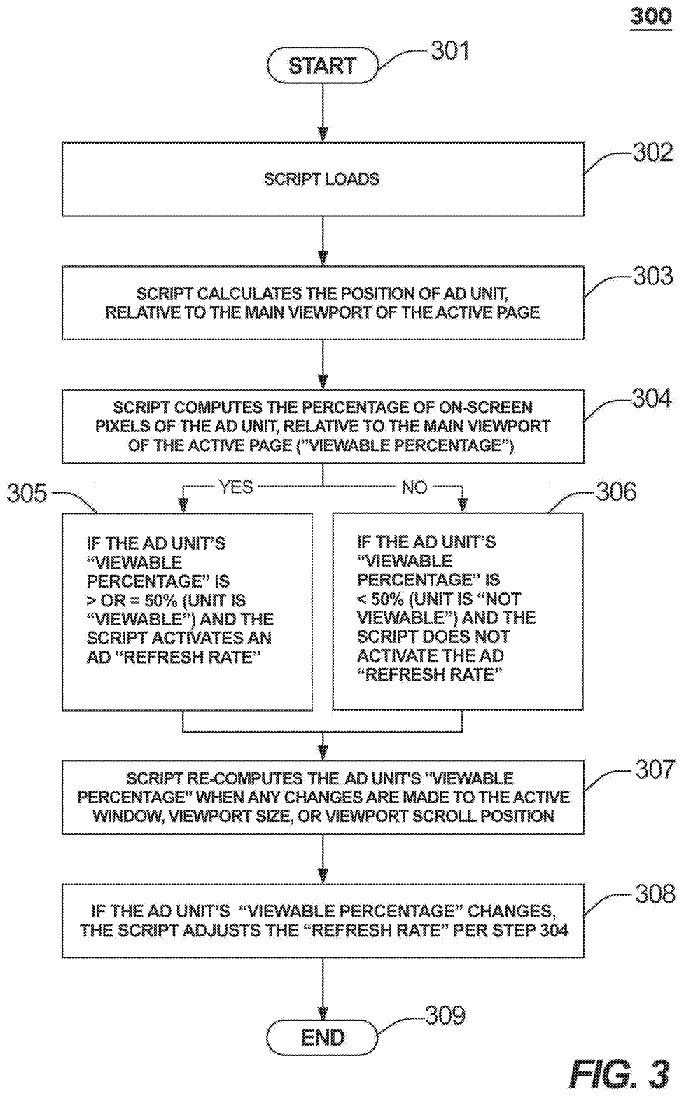

FIG. 3 shows an exemplary method 300 in an embodiment. It should be noted that the methods and systems disclosed herein determine the viewability of ad unit in real time or substantially real time. In one embodiment, the viewability is determined as the web page moves on the user's screen. At step 301, a web page may be loaded. At step 302, a refresh script may be executed and identify, locate, or receive an ad unit. At step 303, the refresh script may calculate a position of an ad unit relative to a main viewport of an active page. At step 304, the refresh script may calculate a percentage of on-screen of the ad unit relative to the main viewport of the active page, which may be referred to as the viewable percentage. At step 304, if the refresh script determines that the viewable percentage is greater than or equal to 50% showing in the active viewport, then the refresh script may execute to make internal calls for advertisements at a faster refresh rate at step 305 by a microprocessor. Alternatively, if at step 304, the refresh script determines that the viewable percentage is less than 50%, showing in the main viewport of the active page, then the ad unit is not viewable or non-viewable, and the script may execute to makes its internal calls for ads at the original refresh rate at step 306 by a microprocessor.

In another embodiment, the script may re-calculate the ad unit's viewable percentage when any changes are made to the active window, viewport size or viewport scroll position at step 307. If at any time the ad unit's viewable percentage changes as determined at 308, the refresh script executes to adjust the refresh rate as per step 304. The method 300 may end when the web page closes at step 309.

In one embodiment, the method of FIG. 3 may be used with infinite scrolling, which refers a web page that loads content continuously as the user scrolls down the page, eliminating the need for pagination. In one embodiment, the refresh script may be executed to calculate the viewability of one or more ads as the web page scrolls.

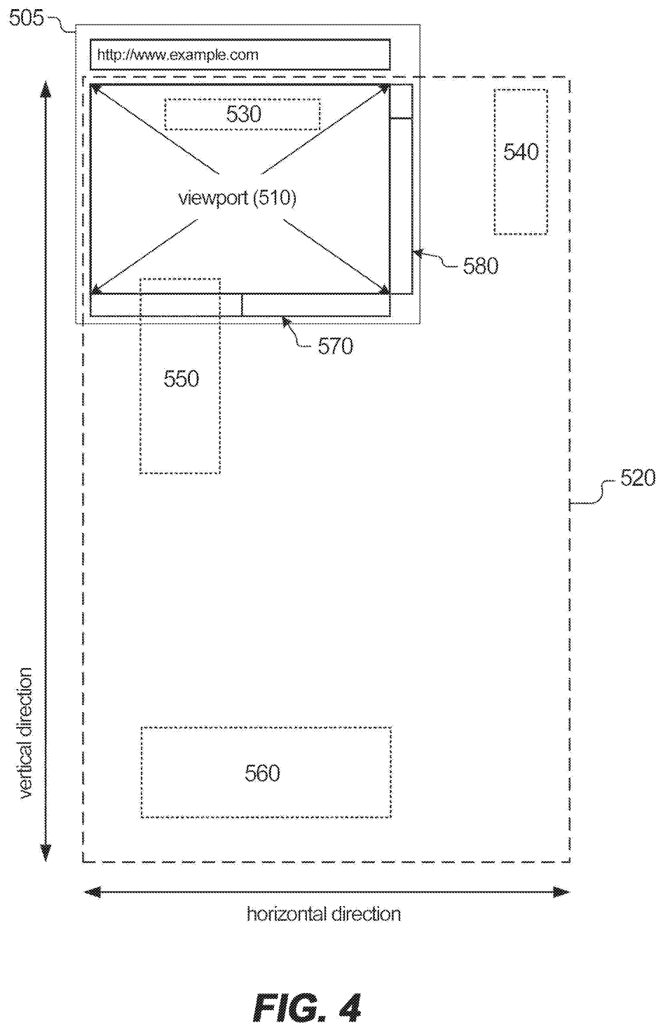

FIG. 4 shows an example of ads rendered on a web page 520 that includes a browser window 505, and an active viewport 510, which may be referred to as the viewable screen space. In one embodiment, the web page may include a horizontal scroll bar 570 and a vertical scroll bar 580. As shown in the FIG. 3, the only viewable ad unit within the active viewport of 510 is 530. Ad units 550, 540 and 560 are all ad units that are not viewable or non-viewable because less than 50% of the ad unit is viewable within the active viewport 510.

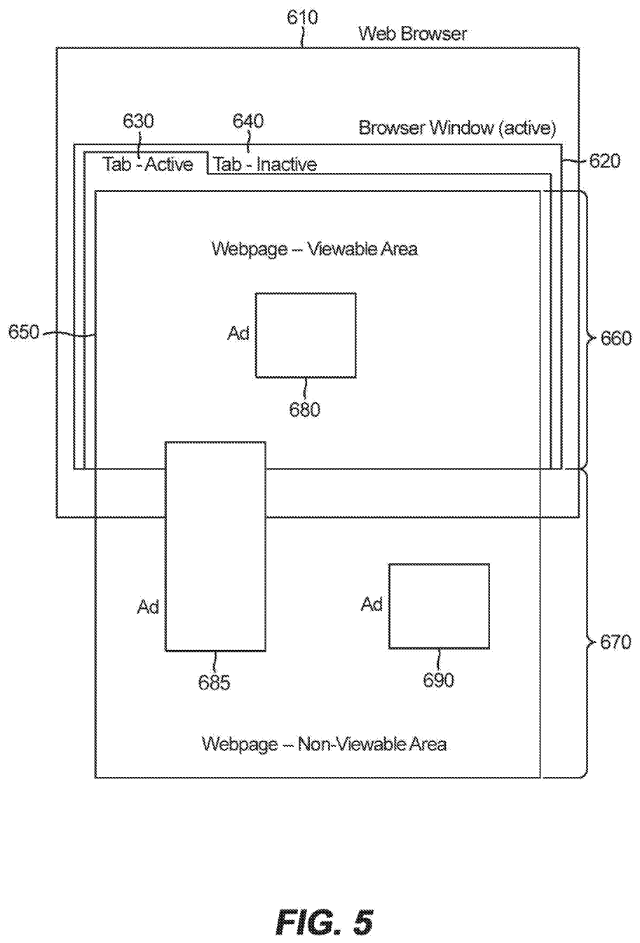

FIG. 5 shows an example of a browser 610 with an active window 660, an active browser tab 630, and an inactive browser tab 640. The dimensions 650 of the web page 650 are also shown. The viewable area 660 of the web page 615 and the non-viewable area 670 of the web page 650 are also shown. The viewable ad unit 680 is shown and an ad unit 685 that has partial viewability is also shown. Ad unit 685 may be considered but not viewable or non-viewable, even though part of the ad unit is in the viewable area. Ad unit 690 may be located in the non-viewable area of the web page.

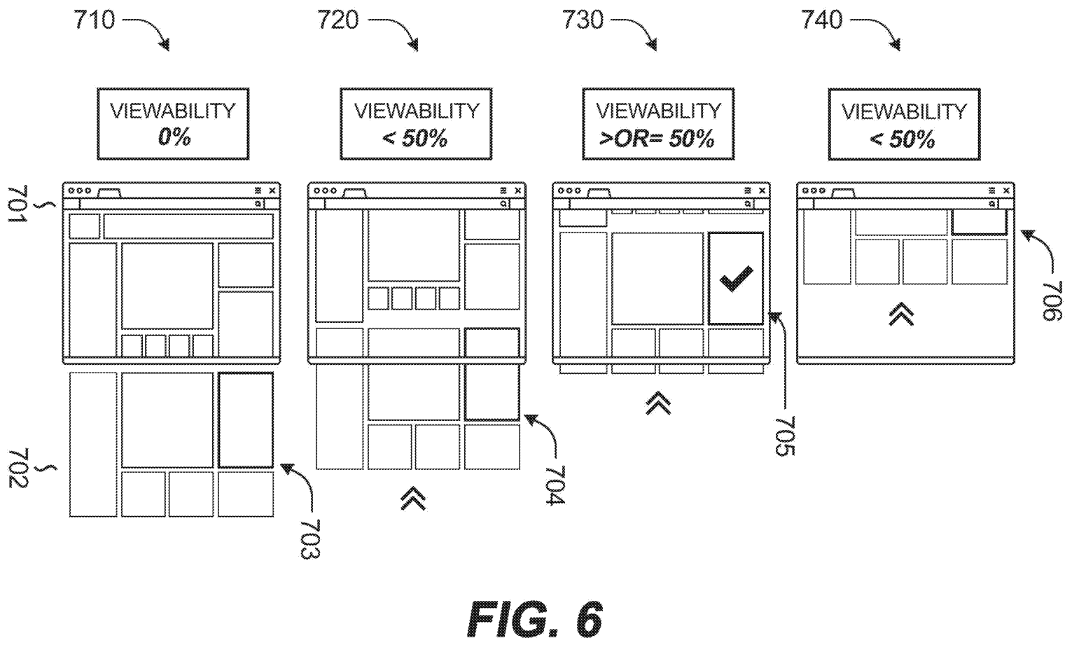

FIG. 6 shows how a non-viewable ad units 703 and 704 may become viewable, such as at 705 and then non-viewable again, such as at 706 based on user scrolling behavior. In one embodiment, an ad unit 710 is shown on the web page below-the-fold 702, which is outside the viewable viewport of the web browser 701. At 720, the page is scrolling up as the ad unit becomes partially viewable. At this stage the original refresh rate may be applied since less than 50% of the advertisement is shown in the viewable area. At 730, the page is scrolling up such that 50% or more of the advertisement is now shown in the active viewport. Accordingly, a faster refresh rate may be applied by executing the refresh script. At 740, the web page has been scrolled up further and the refresh script re-computes the viewable percentage and now the ad unit is less than 50% viewable, which means that less than 50% of the ad unit is within the active viewport. This means the internal calls for ad are made at the original refresh rate by a microprocessor.

Below is refresh script code for automatically delivering content in an embodiment using a refresh script with different refresh rates depending on viewability that may programmed and executed by the microprocessor of the system. It is to be expressly understood that the below is only an example.

// called in response to any change to the viewport (script load, page scroll, window resize,

tab change, etc.)

var checkViewability = function( ) {

var isPageVisible = function( ) {

return top.document.visibilityState == “visible”;

};
var isElementViewable = function(elem, threshold) {

var percent = threshold ∥ 50
var rect = elem.getBoundingClientRect( )
var html = top.document.documentElement
var buffer = 10
// is at least (percent)%(in each axis) of the element on screen? (10px as min buffer size)
var bufferHeight = Math.max(buffer, rect.height * (percent / 100))
var bufferWidth = Math.max(buffer, rect.width * (percent / 100))
return ( !!rect

&& rect.bottom − bufferHeight >= 0 // is not offscreen above
&& rect.right − bufferWidth >= 0 // is not offscreen left
&& rect.top + bufferHeight <= html.clientHeight // is not offscreen below
&& rect.left + bufferWidth <= html.clientWidth // is not offscreen right

)

};
// where adUnitElement is the ad unit on the top-level window
var_pageVisible = isPageVisible( );
var_isViewable = isElementViewable(adUnitElement);
if (_isViewable && _pageVisible) {

// ad unit is viewable
getNewViewableRefreshRate( );

} else {

// ad unit is non-viewable
getNewNonViewableRefreshRate( );

}

};

The foregoing description of the preferred embodiments of the present invention has been presented for purposes of illustration and description. It is not intended to be exhaustive or to limit the invention to the precise form or to exemplary embodiments disclosed. Obviously, many modifications and variations will be apparent to practitioners skilled in this art. Similarly, any process steps described might be interchangeable with other steps in order to achieve the same result. The embodiment was chosen and described in order to best explain the principles of the invention and its best mode practical application, thereby to enable others skilled in the art to understand the invention for various embodiments and with various modifications as are suited to the particular use or implementation contemplated. It is intended that the scope of the invention be defined by the claims appended hereto and their equivalents. Reference to an element in the singular is not intended to mean “one and only one” unless explicitly so stated, but rather means “one or more.” Moreover, no element, component, nor method step in the present disclosure is intended to be dedicated to the public regardless of whether the element, component, or method step is explicitly recited in the following claims. No claim element herein is to be construed under the provisions of 35 U.S.C. Sec. 112, sixth paragraph, unless the element is expressly recited using the phrase “means for . . . .”

It should be understood that the various techniques described herein may be implemented in connection with hardware or software or, where appropriate, with a combination of both. Thus, the methods and apparatus of the presently disclosed subject matter, or certain aspects or portions thereof, may take the form of program code (i.e., instructions) embodied in tangible media, such as floppy diskettes, CD-ROMs, hard drives, or any other machine-readable storage medium where, when the program code is loaded into and executed by a machine, such as a computer, the machine becomes an apparatus for practicing the presently disclosed subject matter.

Although exemplary implementations may refer to utilizing aspects of the presently disclosed subject matter in the context of one or more stand-alone computer systems, the subject matter is not so limited, but rather may be implemented in connection with any computing environment, such as a network or distributed computing environment. Still further, aspects of the presently disclosed subject matter may be implemented in or across a plurality of processing chips or devices, and storage may similarly be affected across a plurality of devices. Such devices might include personal computers, network servers, and handheld devices, for example.

Furthermore, the purpose of the foregoing Abstract is to enable the U.S. Patent and Trademark Office and the public generally, and especially the scientists, engineers and practitioners in the art who are not familiar with patent or legal terms or phraseology, to determine quickly from a cursory inspection the nature and essence of the technical disclosure of the application. The Abstract is not intended to be limiting as to the scope of the present invention in any way. It is also to be understood that the steps and processes recited in the claims need not be performed in the order presented.

1. A computer-implemented method, comprising:
receiving an ad unit including content;
determining automatically by executing a refresh script on a processor in real-time or substantially in real-time whether the ad unit is within an active viewport;
when the ad unit is less than a viewable percentage within the active viewport, applying a first refresh rate, and when the ad unit is equal to or more than the viewable percentage within the active viewport, applying a second refresh rate faster that the first refresh rate.

2. The method of claim 1, wherein the viewable percentage is fifty percent.

3. The method of claim 1, wherein the refresh script automatically calls for new content when the ad unit is equal to or more than the viewable percentage.

4. The method of claim 1 further comprising a web page wherein the web page includes infinite scrolling.

5. The method of claim 1 further comprising calculating a continuous time when the ad unit is equal to or more than the viewable percentage and applying the second refresh rate.

6. The method of claim 1, wherein the active viewport is approximately equal to a web page.

7. The method of claim 1, wherein the determining step occurs when there is one of a change of the viewable area on page scroll, window resize and tab change.

8. An apparatus including a memory and a microprocessor for executing a set of instructions that when executed by the microprocessor perform a method of:
receiving by a microprocessor an ad unit including content;
determining by a microprocessor automatically by executing a refresh script on a processor in real-time or substantially in real-time whether the ad unit is within an active viewport;
when the ad unit is less than a viewable percentage within the active viewport, applying a first refresh rate, and when the ad unit is equal to or more than the viewable percentage within the active viewport, applying a second refresh rate faster that the first refresh rate.

9. The apparatus of claim 8, wherein the viewable percentage is fifty percent.

10. The apparatus of claim 8, wherein the refresh script automatically calls for new content when the ad unit is equal to or more than the viewable percentage.

11. The apparatus of claim 8 further comprising a web page wherein the web page includes infinite scrolling.

12. The apparatus of claim 8 further comprising calculating a continuous time when the ad unit is equal to or more than the viewable percentage and applying the second refresh rate.

13. The apparatus of claim 8, wherein the active viewport is approximately the size of a web page.

14. The apparatus of claim 8, wherein the determining step occurs when there is one of a change of the viewable area on page scroll, window resize and tab change.

15. The apparatus of claim 8 comprising one of a mobile device, laptop, desktop, and tablet.

16. The apparatus of claim 8, wherein one of the first and second refresh rates are approximately 5-60 seconds.

17. The apparatus of claim 8, wherein the ad unit comprises one of 300×250 pixels, 300×600 pixels, 728×90 pixels, 160×600 pixels and 970×250 pixels.

18. The apparatus of claim 8, wherein the content includes a digital advertisement.

19. The method of claim 1, wherein one of the first and second refresh rates are approximately 5-60 seconds.

20. The method of claim 1, wherein the ad unit comprises one of 300×250 pixels, 300×600 pixels, 728×90 pixels, 160×600 pixels, and 970×250 pixels.
